(19) United States
(12) Patent Application Publication
(10) Pub. No.: US 2015/0348189 A1
(43) Pub. Date: Dec. 3, 2015

(54) Restriction of Soft Dollar Overpayments

(71) Applicant: FMR LLC, Boston, MA (US)

(72) Inventor: Vinayakrishna Krishnagiri Thooppal, Bangalore (Bengaluru) (IN)

(73) Assignee: FMR LLC, Boston, MA (US)

(21) Appl. No.: 14/290,162

(22) Filed: May 29, 2014

(51) Int. Cl. G06Q 40/04

(52) U.S. Cl. CPC G06Q 40/04

(57) ABSTRACT

A computer-implemented method, including retrieving, by a computer system from a data repository, a trade execution agreement that specifies an amount of soft dollars payment to be paid to a service provider for execution of a trade order; retrieving, by the computer system from the data repository, information indicative of a soft dollar agreement with the service provider, with the soft dollar agreement specifying an amount of soft dollar payments to be paid to the service provider within a predetermined period; accessing by the computer system trade settlement information that specifies an amount of soft dollar payments that have previously been paid to the service provider; determining by the computer system whether to restrict the amount of soft dollar payments for the trade order.

### BACKGROUND

Generally, “soft dollars” (a common financial industry term for non-reportable payments) are payments for products and services that a service provider (e.g., an investment manager) receives from or through a broker-dealer in exchange for providing products and services to a trading institution that deals with the broker-dealer and in exchange for a trading institution's direction of client brokerage financial transactions to the broker-dealer. Soft dollars are the part of the trade settlement payout and/or commission paid by the trading institution to the broker-dealer and which the trading institutions can use for various purposes such as buying research from the broker dealer or an affiliate. Soft dollars do not include trading costs for execution of securities transactions.

Trade execution costs and the soft dollar amounts are bundled as one trade settlement payout and are paid by the trading institution to the broker at trade settlement. The amount allocated towards trade execution costs and the amount allocated towards soft dollar costs depend on the specific agreement between the trading institution and the broker. Such agreements depend on (the service provider offering the services (e.g., the trading broker or other third party with an affiliation with the broker), the trading broker, the trading desk, the market region and the threshold amount that classify a trade as a soft dollar trade.

During a reconciliation process, the trading institution determines whether there was an overpayment of soft dollars, e.g., the amount of soft dollar payments exceeds the specified amount per the agreement with the service provider. Overpayment of soft dollars can occur when a large number of trades are executed with a broker, e.g., the broker who provides the best execution price and security prices. During the reconciliation process, the trading institution recaptures the overpaid amounts from the service provider. These recaptured amounts may also be a rebate from the broker. The trading institution may also recapture the overpaid amounts by adjusting amounts of soft dollar payments in the next agreement period.

### SUMMARY

In an implementation, a computer-implemented method includes retrieving, by a computer system from a data repository, a trade execution agreement that specifies an amount of soft dollars payment to be paid to a service provider for execution of a trade order; retrieving, by the computer system from the data repository, information indicative of a soft dollar agreement with the service provider, with the soft dollar agreement specifying an amount of soft dollar payments to be paid to the service provider within a predetermined period; accessing by the computer system trade settlement information that specifies an amount of soft dollar payments that have previously been paid to the service provider; determining by the computer system whether to restrict the amount of soft dollar payments for the trade order.

The actions include determining whether to restrict based on the amount of soft dollar payments specified in the soft dollar agreement, the amount of soft dollar payments that have previously been paid and the amount of soft dollar payments to be paid for the trade order. The actions include transmitting, by the computer system, a request to execute the trade order. The actions include determining that the amount of the soft dollar payments for the trade order and the amount of soft dollar payments that have previously been paid are in the aggregate less than or equal to the amount of soft dollar payments specified in the soft dollar agreement; and transmitting, to a device of a broker, instructions to pay the determined amount of soft dollar payments to the service provider. The amount of the soft dollar payments for the trade order are an original amount of soft dollar payments, and the method further comprises: determining that an aggregate of the original amount of the soft dollar payments and the amount of soft dollar payments that have previously been paid exceeds the amount of soft dollar payments specified in the soft dollar agreement; reducing the original amount of soft dollar payments by a restriction amount, with the restriction amount being the amount that the aggregate of the original amount of the soft dollar payments and the amount of soft dollar payments that have previously been paid exceeds the amount of soft dollar payments specified in the soft dollar agreement; and transmitting to a device of a broker a trade settlement payout and instructions to distribute the reduced amount of soft dollar payments to the service provider.

When the trade order is a bulk trade order, the method further comprises: determining that an aggregate of the amount of the soft dollar payments for the bulk trade order and the amount of soft dollar payments that have previously been paid exceeds the amount of soft dollar payments specified in the soft dollar agreement; determining an amount of soft dollar payments that does not result in an overpayment of soft dollars; based on the determined amount of soft dollar payments that does not result in the overpayment, determining a portion of the bulk trade order for which soft dollars are paid, with the soft dollars paid on the determined portion being in accordance with the determined amount of soft dollar payments that does not result in the overpayment; transmitting to a device of a broker a first trade settlement payout for the portion of the block trade order and instructions to distribute soft dollar payments for the first trade settlement payout; for the remaining portion of the block trade order, removing soft dollar payments from a second trade settlement payout for the remaining portion; and transmitting to the device of a broker the second trade settlement payout with the soft dollar payments removed. The actions include tracking an amount of soft dollar payments made to the service provider; detecting that the amount of soft dollar payments exceeds the amount of soft dollars payments specified in the soft dollar agreement; and recapturing an excess amount of soft dollar payments by transmitting to a device of a broker instructions to credit back to a trading institution the excess amount of soft dollar payments. The request to execute the trade order is transmitted to a device of a broker.

All or part of the foregoing may be implemented as a computer program product including instructions that are stored on one or more non-transitory machine-readable storage media and/or one or more computer-readable hardware storage devices that are a hard drive, a random access memory storage device, such as a dynamic random access memory, machine-readable hardware storage devices, and other types of non-transitory machine-readable storage devices, and that are executable on one or more processing devices. All or part of the foregoing may be implemented as an apparatus, method, or electronic system that may include one or more processing devices and memory to store executable instructions to implement the stated functions.

The details of one or more embodiments are set forth in the accompanying drawings and the description below. Other features, objects, and advantages of the techniques described herein will be apparent from the description and drawings, and from the claims.

### DESCRIPTION OF DRAWINGS

FIG. 1 is a diagram of a system for restricting excess soft dollar payments.

FIG. 2 is a block diagram of components of a system for restricting excess soft dollar payments.

FIGS. 3A and 3B are a flow chart detailing processes for mitigating excess soft dollar payments.

### DETAILED DESCRIPTION

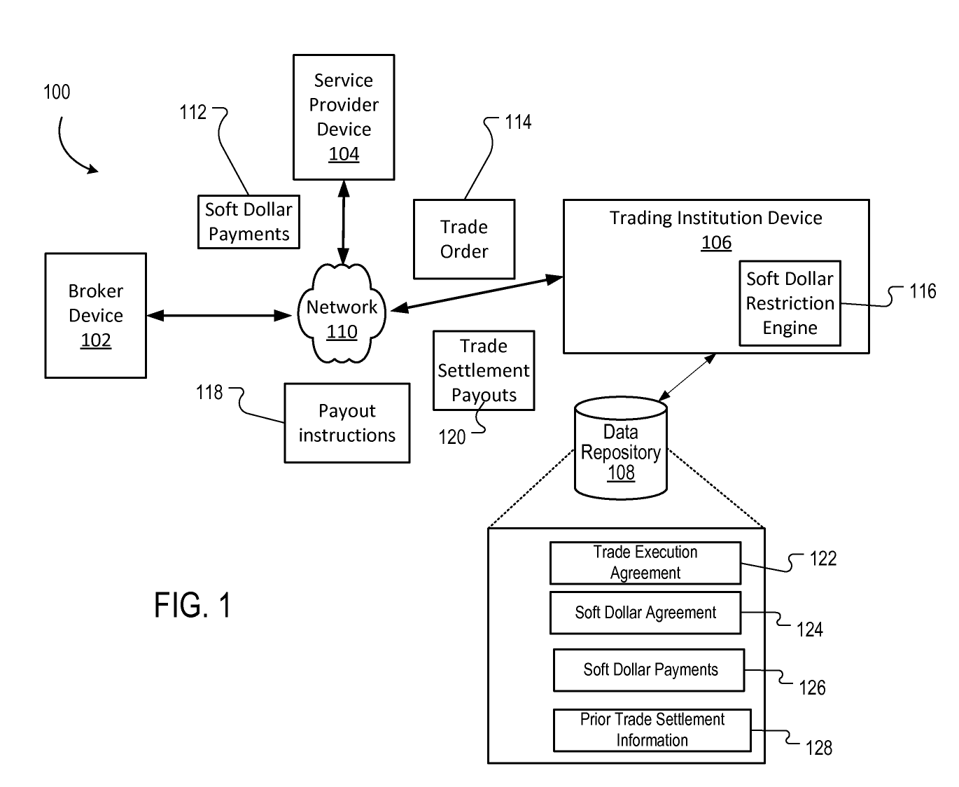

Referring to FIG. 1, system 100 includes trading institution device 106 of a trading institution that trades securities. System 100 also includes broker device 102 of a broker that executes a trade ordered by the trading institution. System 100 also includes service provider device 104 of a service provider that provides various services (e.g., research services) to the trading institution. Broker device 102, service provider device 104, and trading institution device 106 communicate with each other over network 110. System 100 also includes data repository 108 for storage of various types of information. In a variation of FIG. 1, a broker and a service provider are the same entity. A single entity performs the actions of the service provider and broker described herein.

Data repository 108 stores a trade execution agreement 122, i.e., an agreement between the trading institution and the broker regarding the services the broker provides. The trade execution agreement 122 specifies an amount of commission the broker receives for execution of a trade.

The trade execution agreement 122 also specifies an amount of soft dollar payments that are distributed from the trade settlement payout to the service provider. The broker distributes the soft dollar payments to the service provider. The trade execution agreement 122 also specifies an amount of the commission that is paid to the broker for trade costs.

Data repository 108 also stores soft dollar agreement 124 that is an agreement between the trading institution and the service provider. Soft dollar agreement 124 specifies a particular (e.g., maximum) amount of funds to be paid by the trading institution to the service provider (e.g., per agreement period). In an example, the soft dollar agreement 124 specifies a cap on an amount of soft dollar payments to be paid to a service provider during a predetermined time period (e.g., agreement period). To execute a trade, trading institution device 106 transmits (via network 110) trader order 114 to broker device 102.

Trading institution device 106 also initiates execution of a settlement process for the trade specified by trade order 114. The settlement process occurs two or three days after transmission of trade order 114. When a trade order is executed, the trading costs, which include security price, execution commissions and soft dollar payments, are paid to the broker. The soft dollar payments (e.g., accumulated over time) pay for the services provided by the service providers and services (other than that of trade executions) provided by the brokers.

During the settlement process, trading institution device 106 executes (in real-time) soft dollar restriction engine 116 for predicting when a soft dollar payment results in an overpayment of soft dollars (e.g., for a particular service provider). By integrating this prediction into the settlement process and through use of real-time data indicative of prior soft dollar payments and soft dollar caps, soft dollar restriction engine 116 places restrictions on soft dollar payments that can mitigate the occurrence of overpayment of soft dollars.

When soft dollar restriction engine 116 detects that a soft dollar payment will result in an overpayment, soft dollar restriction engine 116 restricts (e.g., reduces or eliminates) the amount of soft dollar payment at least to an amount that will substantially mitigate the overpayment.

For the trade specified by trade order 114, soft dollar restriction engine 116 determines an amount of soft dollar payments that are due in accordance with trade execution agreement 122. In an example, trade execution agreement 122 specifies that one percent of the dollar amount of the trade order is paid as soft dollar payments to a particular service provider. Based on trade execution agreement 122 and the dollar amount of the trade order, soft dollar restriction engine 116 determines soft dollar payment information 126, e.g., the amount of soft dollars to be paid for the particular service provided for the trade. Soft dollar restriction engine 116 saves soft dollar payment information (i.e., soft dollar payments 126) in data repository 108.

Soft dollar restriction engine 116 also determines an amount of soft dollars that have previously been paid to the particular service provider during the agreement period. Soft dollar restriction engine 116 retrieves from data repository 108 prior trade settlement information 128, which includes information specifying prior commissions that have been paid to brokers during the agreement period and amounts of soft dollar payments that were previously paid to various service providers. Soft dollar restriction engine 116 parses prior trade settlement information 128 to identify previously paid soft dollar amounts that were paid to the service provider associated with service provider device 104.

Soft dollar restriction engine 116 generates an aggregate amount of soft dollar payments by aggregating together soft dollar payments 126 for the current trade with the previously paid soft dollar payments. The aggregate amount of soft dollar payments represents a total amount of soft dollar payments that would be paid to the service provider if the trading institution makes soft dollar payments in accordance with the terms specified in trade execution agreement 122 and independent of the terms specified in soft dollar agreement 124.

Soft dollar restriction engine 116 compares the aggregate amount of soft dollar payments to the amount of soft dollar payments specified in soft dollar agreement 124. If soft dollar restriction engine 116 determines that the aggregate amount of soft dollar payments is less than or equal to the amount of soft dollar payments specified in soft dollar agreement 124, soft dollar restriction engine 116 determines that payment of soft dollars in an amount specified by trade execution agreement 122 is in compliance with soft dollar agreement 124 (e.g., there is no overpayment of soft dollars).

When soft dollar restriction engine 116 determines that the aggregate amount of soft dollar payments exceeds the amount of soft dollars specified in soft dollar agreement 124, soft dollar restriction engine 116 determines that payment of soft dollars in the amount specified by the trade execution agreement 122 would result in an overpayment of soft dollars. Soft dollar restriction engine 116 determines an amount by which the soft dollars to pay are reduced, prevent the overpayment.

To prevent the overpayment, soft dollar restriction engine 116 determines an amount by which the soft payments are reduced, in accordance with the equation in Table 1:

TABLE 1
Restriction Amount = Aggregate Amount of Soft Dollar Payments −
Specified Amount of Soft Dollar Payments in Soft Dollar Agreement

As shown in the above Table 1, soft dollar restriction engine 116 determines a restriction amount, i.e., an amount by which to restrict soft dollar payments to a service provider. Soft dollar restriction engine 116 determines the restriction amount by subtracting the amount of soft dollar payments specified in soft dollar agreement 124 from the aggregate amount of soft dollar payments.

As shown in Table 2 below, the specified amount of soft dollar payments (per soft dollar agreement 124) is $150. The amount of previously paid soft dollars is $130. The new amount of soft dollar payments per trade execution agreement 122 is $70. The aggregate amount of soft dollar payments is $200.

TABLE 2
Specified amount of soft dollar payments = $150
Previously paid soft dollar payments = $130
New amount of soft dollar payments = $70
Previously paid soft dollar payments + New amount of soft dollar
payments = Aggregate amount of soft dollar payments or
($130 + $70 = $200)
Aggregate amount of soft dollar payments − Specified amount of soft
dollar payments = Restriction amount or ($200 − $150 = $50)

As shown in Table 2 above, the calculated restriction amount is fifty dollars. Based on the restriction amount, soft dollar restriction engine 116 reduces soft dollar payments 126 by the restriction amount (i.e., by fifty dollars).

Following the settlement process, trading institution device 106 issues trade settlement payouts 120 (commission payments with soft dollar payments) to broker device 102. Trading institution device 106 also transmits to broker device 102 payout instructions 118 specifying which portion of trade settlement payouts 120 is to be allocated to a service provider as a soft dollar payment. When the amount of soft dollar payments is restricted (e.g., to prevent overpayment), trade settlement payouts 120 reflect the restricted amount of soft dollar payments and payout instructions 118 instruct the broker to payout to the service provider the restricted amount of soft dollars.

Using payout instructions 118, broker device 102 issues soft dollar payments 112 to the service provider through service provider device 104. Trading institution device 106 also determines if an overpayment of soft dollars has occurred, e.g., if the amount of soft dollars paid out to a service provider exceeds the amount of soft dollars specified in soft dollar agreement 124 for the particular service provider. If trading institution device 106 detects an overpayment, trading institution device 106 recaptures the amount of the overpayment by issuing to broker device 102 a request for a rebate in the amount of the overpayment.

In a variation, a trade order that is a bulk or block trade order (e.g., for a larger volume of securities, e.g., 10,000 shares is a common block size) may result in an overpayment of soft dollars. To prevent the overpayment, commissions for a portion of the traded securities in the bulk trade order include soft dollar payments and commissions for the remaining portion do not include soft dollar payments.

Soft dollar restriction engine 116 determines whether soft dollar payments in accordance with soft dollar agreement 124 cause an overpayment. When soft dollar restriction engine 116 detects that an overpayment would occur, soft dollar restriction engine 116 determines a restriction amount. Using the restriction amount, soft dollar restriction engine 116 reduces the soft dollar payments to be in accordance with soft dollar agreement 124. Soft dollar restriction engine 116 determines a portion of the bulk trade order for which soft dollar payments match the reduced amount of soft dollar payments. Soft dollar restriction engine 116 determines a portion of the bulk order with a dollar trade amount that provides for a soft dollar payment in the reduced amount.

Trading institution device 106 issues to broker device 102 a commission for that portion of the bulk trade order and instructs the broker to pay the service provider the reduced amount of soft dollar payments. Trading institution device 106 also issues to broker device 102 a commission for the remaining portion of the bulk trade order and instructs the broker that none of the commission is for soft dollar payments.

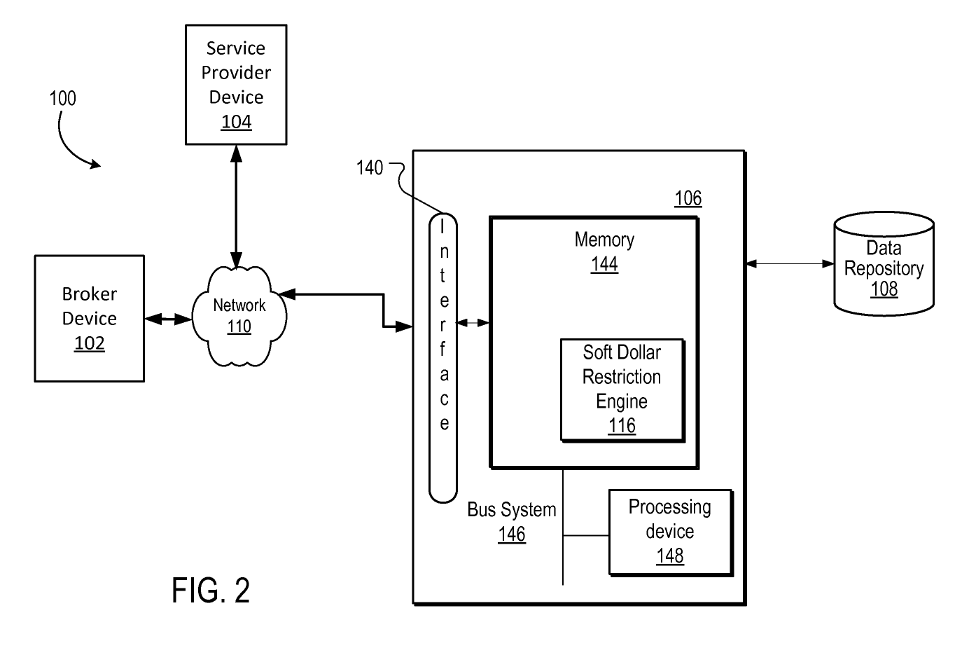

Referring to FIG. 2, broker device 102 and service provider device 104 can each be any sort of computing device capable of taking input from a user and communicating over network 110 with trading institution device 106 and/or with other client devices. For example, broker device 102 and service provider device 104 can each be mobile devices, desktop computers, laptops, cell phones, personal digital assistants (“PDAs”), iPhone, smart phones, iPads, servers, embedded computing systems, and so forth.

Trading institution device 106 also includes memory 144, a bus system 146, and a processor 148. Memory 144 can include a hard drive and a random access memory storage device, such as a dynamic random access memory, machine-readable media, machine-readable hardware storage devices, or other types of non-transitory machine-readable storage devices. Memory 144 stores various computer programs, e.g., soft dollar restriction engine 116. A bus system 146, including, for example, a data bus and a motherboard, can be used to establish and to control data communication between the components of trading institution device 106. Processor 148 may include one or more microprocessors and/or processing devices. Generally, processor 148 may include any appropriate processor and/or logic that is capable of receiving and storing data, and of communicating over a network (not shown).

Trading institution device 106 can be any of a variety of computing devices capable of receiving data, such as a server, a distributed computing system, a desktop computer, a laptop, a cell phone, a rack-mounted server, cloud computing device, and so forth. Trading institution device 106 may be a single server or a group of servers that are at a same location or at different locations. Trading institution device 106 can receive data from client devices (e.g., broker device 102 and service provider device 104) via input/output (“I/O”) interface 140. I/O interface 140 can be any type of interface capable of receiving data over a network, such as an Ethernet interface, a wireless networking interface, a fiber-optic networking interface, a modem, and so forth.

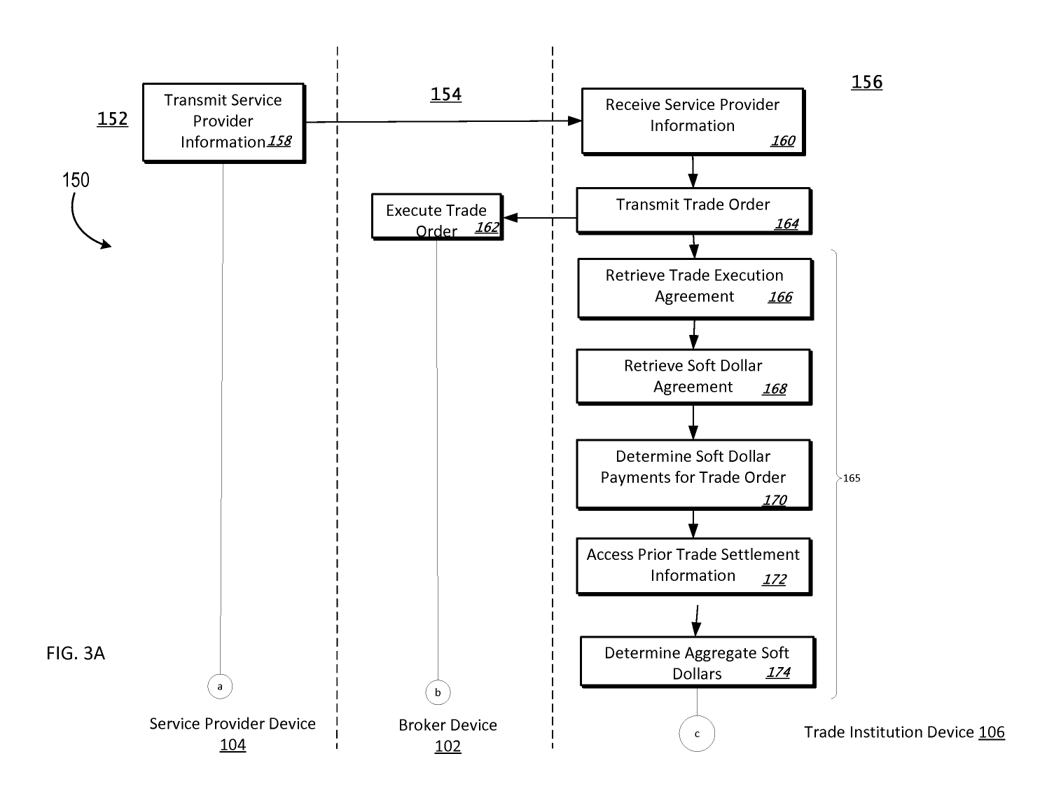

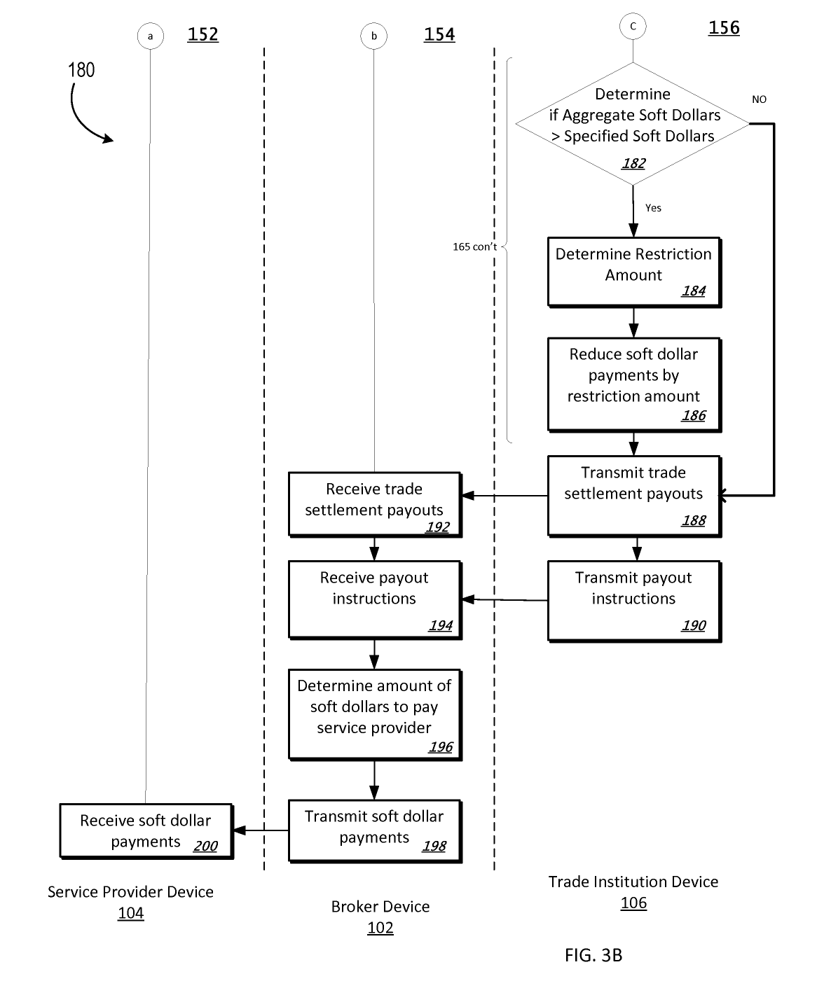

Referring to FIGS. 3A and 3B, process 150 is implemented for trade order execution and trade settlement processing.

FIGS. 3A and 3B include section 152 pertaining to actions implemented by service provider device 104, section 154 for pertaining to actions implemented by broker device 102 and section 156 pertaining to actions implemented by trading institution device 106.

Service provider device 104 transmits (158) service provider information to trading institution device 106. Service provider information is used by the trading institution in selecting trades for execution. There are various types of service provider information, including, e.g., research information, profitability information of various companies, information that specifies the expected growth of various securities, and so forth. Trading institution device 106 receives (160) the service provider information and uses the service provider information in selecting which securities to trade. The service provider causes the service provider information to be transmitted at various time intervals and throughout an agreement period, as specified in a soft dollar agreement between the service provider and the trading institution.

Trading institution device 106 transmits (164) a trade order to broker device 102. Broker device 102 receives the trade order and executes (162) the trade order. As part of a settlement process executed between the trading institution device 106 and broker dealer, that trading institution computers executes actions including actions 166, 168, 170, 172, and 174. Trading institution device 106 implements its portion of the settlement at various times, including, e.g., hours after transmission of the trade order, days after transmission of the trade order and so forth. Trading institution device 106 retrieves (166), from a data repository, a trade execution agreement that specifies an amount of soft dollar payments for the trade. Trading institution device 106 also retrieves (168) a soft dollar agreement which specifies a cap (e.g., a maximum) on the amount of soft dollar payments the trading institution pays the service provider during the agreement period. Using details of the trade order (e.g., a volume of the securities to be traded, the trade execution price, and so forth) and the amount of soft dollars for the trade specified in the trade execution agreement, trading institution device 106 determines (170) an amount of soft dollar payments for the trade order. Trading institution device 106 accesses (172), from the data repository, prior trade settlement information. Based on contents of the prior trade settlement information, trading institution device 106 determines an amount of soft dollars that have already been paid to the service provider during the agreement period. Trading device institution 106 determines (174) an amount of aggregate soft dollars, by aggregating together the amount of soft dollars that are to be paid for execution of the trade order (per the trade execution agreement) and the amount of soft dollars that have previously been paid.

Referring to FIG. 3B, trading institution device 106 determines (182) whether the amount of aggregate soft dollars exceeds the amount of soft dollars specified in the soft dollar agreement (e.g., the cap on the amount of soft dollar payments). Trading institution device 106 determines that the current trade order would cause an overpayment of soft dollars when the amount of aggregate soft dollars exceeds the amount of soft dollars specified in the soft dollar agreement. When trading institution device 106 determines that the amount of aggregate soft dollars is less than or equal to the amount of soft dollars specified in the soft dollar agreement, trading institution device 106 transmits trade settlement payouts to the broker, as described in further detail below.

When trading institution device 106 determines that the amount of aggregate soft dollars exceeds the amount of soft dollars specified in the soft dollar agreement, trading institution device 106 determines (184) a restriction amount, i.e., an amount by which to restrict the soft dollar payments for the current trade order. Trading institution device 106 determines the restriction amount by determining the amount by which the amount of aggregate soft dollars exceeds the soft dollar cap. Trading institution device 106 reduces (186) the amount of soft dollar payments by the restriction amount. Trading institution device 106 transmits (188) trade settlement payouts to broker device 102, e.g., to pay the broker the commission for the trade execution and to pay out the soft dollars. Trading institution device 106 also generates and transmits (190) payout instructions to broker device. The payout instructions specify a portion of the trade settlement payout that is for the broker for a commission and a portion of the trade settlement payout that is for soft dollar payments to the service provider.

The broker device 102 receives (192) the trade settlement payouts and also receives (194) the payout instructions. Using contents of the payout instructions, the broker device 192 determines (196) an amount of soft dollars to be paid to the service provider. The amount of soft dollars to be paid to the service provider is a restricted amount of soft dollars, when payment of an unrestricted amount of soft dollars would result in an overpayment of soft dollars. Broker device 102 transmits (198) (via an electronic transmission) the soft dollar payments to the service provider device 104. The service provider device 104 receives (200) the soft dollar payments. The payments to the service provider may not happen as and when the trades are settled. Rather, these soft dollar amounts for each trade settlement may be aggregated and paid to the service provider at the end of the agreement period.

Embodiments can be implemented in digital electronic circuitry, or in computer hardware, firmware, software, or in combinations thereof. Apparatus can be implemented in a computer program product tangibly embodied or stored in a machine-readable storage device for execution by a programmable processor; and method actions can be performed by a programmable processor executing a program of instructions to perform functions by operating on input data and generating output. The techniques described herein can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled and/or an interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Other embodiments are within the scope and spirit of the description and the claims. Additionally, due to the nature of software, functions described above can be implemented using software, hardware, firmware, hardwiring, or combinations of any of these. Features implementing functions may also be physically located at various positions, including being distributed such that portions of functions are implemented at different physical locations. The use of the term “a” herein and throughout the application is not used in a limiting manner and therefore is not meant to exclude a multiple meaning or a “one or more” meaning for the term “a.” Additionally, to the extent priority is claimed to a provisional patent application, it should be understood that the provisional patent application is not limiting but includes examples of how the techniques described herein may be implemented.

A number of embodiments have been described. Nevertheless, it will be understood that various modifications may be made without departing from the spirit and scope of the claims and the examples of the techniques described herein.

1. A computer-implemented method, comprising:
retrieving, by a computer system from a data repository, data pertaining an original amount of soft dollar payments to be paid to a service provider for execution of a trade order;
retrieving, by the computer system from the data repository, data pertaining to an amount of soft dollar payments to be paid to the service provider within a predetermined period;
accessing by the computer system trade settlement information that specifies an amount of soft dollar payments previously been paid to the service provider during a specified period;
executing by the computer system a settlement process to settle trades with the trade settlement process comprising a soft dollar restriction engine to predict when a soft dollar payment would result in an overpayment of soft dollars by determining whether an aggregate of the original amount of the soft dollar payments and the amount of soft dollar payments previously been paid will exceed the amount of soft dollar payments specified to be paid within the predetermined period;
determining, by the computer system based on execution of the soft dollar restricting engine prediction to restrict the amount of soft dollar payments for the trade order;
determining by the computer system a restriction amount that is the aggregate of the original amount of the soft dollar payments and the amount of soft dollar payments previously paid that exceed the amount of soft dollar payments specified in the soft dollar agreement and reducing the original amount of soft dollar payments by the restriction amount; and
transmitting to a device of a broker a trade settlement payout and instructions to distribute the reduced amount of soft dollar payments to the service provider.

2. The computer-implemented method of claim 1, further comprising:
determining whether to restrict based on the amount of soft dollar payments specified in the soft dollar agreement, the amount of soft dollar payments that have previously been paid and the original amount of soft dollar payments to be paid for the trade order.

3. The computer-implemented method of claim 1, further comprising:
transmitting, by the computer system, a request to execute the trade order.

4. The computer-implemented method of claim 1, further comprising:
determining that another amount of the soft dollar payments for another trade order and the amount of soft dollar payments that have previously been paid are in the aggregate less than or equal to the amount of soft dollar payments specified in the soft dollar agreement; and
transmitting, to a device of a broker, instructions to pay the determined other amount of soft dollar payments to the service provider.

5. (canceled)

6. A computer-implemented method comprising:
retrieving, by a computer system from a data repository, data that specifies an amount of soft dollar payments to be paid to a service provider for execution of a bulk trade order;
retrieving, by the computer system from the data repository, information specifying an amount of soft dollar payments to be paid to the service provider within a predetermined period;
accessing by the computer system trade settlement information that specifies an amount of soft dollar payments that have previously been paid to the service provider;
predicting, by execution of a soft dollar restriction engine in the computer system, when a soft dollar payment results in an overpayment of soft dollars by determining that an aggregate of the amount of the soft dollar payments for the bulk trade order and the amount of soft dollar payments that have previously been paid will exceed the amount of soft dollar payments to be paid within the predetermined period;
determining, by the computer system based on the predicting of an overpayment to restrict the amount of soft dollar payments for the bulk trade order and determine an amount of soft dollar payments that does not result in an overpayment of soft dollars;
determining by the computer based on the determined amount of soft dollar payments that does not result in the overpayment for the bulk trade order an amount of soft dollars to pay in accordance with the determined amount of soft dollar payments that does not result in the overpayment;
transmitting to a device of a broker a first trade settlement payout for the portion of the block trade order and instructions to distribute soft dollar payments for the first trade settlement payout;
for the remaining portion of the block trade order, removing soft dollar payments from a second trade settlement payout for the remaining portion; and
transmitting to the device of a broker the second trade settlement payout with the soft dollar payments removed.

7. The computer-implemented method of claim 1, further comprising:
tracking an amount of soft dollar payments made to the service provider;
detecting that the amount of soft dollar payments exceeds the amount of soft dollar payments specified in the soft dollar agreement; and
recapturing an excess amount of soft dollar payments by transmitting to a device of a broker instructions to credit back to a trading institution the excess amount of soft dollar payments.

8. The computer-implemented method of claim 1, wherein the request to execute the trade order is transmitted to a device of a broker.

9. A computer program product tangibly stored on a computer readable hardware storage device, the computer program product comprising instructions for causing one or more processing devices to:
retrieve, from a data repository, data pertaining to an original amount of soft dollar payments to be paid to a service provider for execution of a trade order;
retrieve, from the data repository, data pertaining to an amount of soft dollar payments to be paid to the service provider within a predetermined period;
access trade settlement information that specifies an amount of soft dollar payments previously been paid to the service provider during a specified period;
execute a trade settlement process to settle trades, with the trade settlement process predicting, when a soft dollar payment results in an overpayment of soft dollars by determining whether an aggregate of the original amount of the soft dollar payments and the amount of soft dollar payments that have previously been paid exceeds the amount of soft dollar payments specified;
determine, based on predicting, to restrict the amount of soft dollar payments for the trade order;
determine a restriction amount that is the aggregate of the original amount of the soft dollar payments and the amount of soft dollar payments previously paid that exceed the amount of soft dollar payments specified in the soft dollar agreement to reduce the original amount of soft dollar payments by the restriction amount; and
transmit to a device of a broker a trade settlement payout and instructions to distribute the reduced amount of soft dollar payments to the service provider.

10. The computer program product of claim 9, further comprising instructions for causing the one or more processing devices to:
determine whether to restrict based on the amount of soft dollar payments specified in the soft dollar agreement, the amount of soft dollar payments that have previously been paid and the original amount of soft dollar payments to be paid for the trade order.

11. The computer program product of claim 9, further comprising instructions for causing the one or more processing devices to:
transmit a request to execute the trade order.

12. The computer program product of claim 9, further comprising instructions for causing the one or more processing devices to:
determine that another amount of the soft dollar payments for another trade order and the amount of soft dollar payments that have previously been paid are in the aggregate less than or equal to the amount of soft dollar payments specified in the soft dollar agreement; and
transmit, to a device of a broker, instructions to pay the determined other amount of soft dollar payments to the service provider.

13. (canceled)

14. A computer program product tangibly stored on a computer readable hardware storage device, the computer program product comprising instructions for causing one or more processing devices to:
retrieve, from a data repository, data that specifies an amount of soft dollar payments to be paid to a service provider for execution of a bulk trade;
retrieve, from the data repository, data pertaining to an amount of soft dollar payments to be paid to the service provider within a predetermined period;
access trade settlement information that specifies an amount of soft dollar payments that have previously been paid to the service provider during a specified period;
predict, by execution of a soft dollar restriction engine in the one or more processing devices, when a soft dollar payment results in an overpayment of soft dollars by determining that an aggregate of the amount of the soft dollar payments for the bulk trade order and the amount of soft dollar payments that have previously been paid will exceed the amount of soft dollar payments to be paid within the predetermined period;
determine based on the prediction of an overpayment to restrict the amount of soft dollar payments for the bulk trade order and determine an amount of soft dollar payments that does not result in an overpayment of soft dollars;
determine based on the determined amount of soft dollar payments that does not result in the overpayment for the bulk trade order an amount of soft dollars to pay in accordance with the determined amount of soft dollar payments that does not result in the overpayment;
transmit to a device of a broker a first trade settlement payout for the portion of the block trade order and instructions to distribute soft dollar payments for the first trade settlement payout;
for the remaining portion of the block trade order, remove soft dollar payments from a second trade settlement payout for the remaining portion; and
transmit to the device of a broker the second trade settlement payout with the soft dollar payments removed.

15. The computer program product of claim 9, further comprising instructions for causing the one or more processing devices to:
track an amount of soft dollar payments made to the service provider;
detect that the amount of soft dollar payments exceeds the amount of soft dollar payments specified in the soft dollar agreement; and
recapture an excess amount of soft dollar payments by transmitting to a device of a broker instructions to credit back to a trading institution the excess amount of soft dollar payments.

16. The computer program product of claim 9, wherein the request to execute the trade order is transmitted to a device of a broker.

17. A system comprising:
one or more processing devices; and
a computer program product tangibly stored on a computer readable hardware storage device, the computer program product comprising instructions for causing the one or more processing devices to:
retrieve, from a data repository, data pertaining to an original amount of soft dollar payments to be paid to a service provider for execution of a trade order;
retrieve, from the data repository, data pertaining to an amount of soft dollar payments to be paid to the service provider within a predetermined period;
access trade settlement information that specifies an amount of soft dollar payments previously been paid to the service provider during a specified period;
execute a trade settlement process to settle trades, with the trade settlement process predicting, when a soft dollar payment results in an overpayment of soft dollars by determining whether an aggregate of the original amount of the soft dollar payments and the amount of soft dollar payments that have previously been paid exceeds the amount of soft dollar payments specified;
determine, based on predicting, to restrict the amount of soft dollar payments for the trade order;
determine a restriction amount that is the aggregate of the original amount of the soft dollar payments and the amount of soft dollar payments previously paid that exceed the amount of soft dollar payments specified in the soft dollar agreement to reduce the original amount of soft dollar payments by the restriction amount; and
transmit to a device of a broker a trade settlement payout and instructions to distribute the reduced amount of soft dollar payments to the service provider.

18. The system of claim 17, wherein the computer program product further comprises instructions for causing the one or more processing devices to:
determine whether to restrict based on the amount of soft dollar payments specified in the soft dollar agreement, the amount of soft dollar payments that have previously been paid and the original amount of soft dollar payments to be paid for the trade order.

19. The system of claim 17, wherein the computer program product further comprises instructions for causing the one or more processing devices to:
transmit a request to execute the trade order.

20. The system of claim 17, wherein the computer program product further comprises instructions for causing the one or more processing devices to:
determine that another amount of the soft dollar payments for another trade order and the amount of soft dollar payments that have previously been paid are in the aggregate less than or equal to the amount of soft dollar payments specified in the soft dollar agreement; and
transmit, to a device of a broker, instructions to pay the determined other amount of soft dollar payments to the service provider.

21. (canceled)

22. A system comprising:
one or more processing devices; and
a computer program product tangibly stored on a computer readable hardware storage device, the computer program product comprising instructions for causing the one or more processing devices to:
retrieve, from a data repository, data that specifies an amount of soft dollar payments to be paid to a service provider for execution of a bulk trade;
retrieve, from the data repository, data pertaining to an amount of soft dollar payments to be paid to the service provider within a predetermined period;
access trade settlement information that specifies an amount of soft dollar payments that have previously been paid to the service provider during a specified period;
predict, by execution of a soft dollar restriction engine in the one or more processing devices, when a soft dollar payment results in an overpayment of soft dollars by determining that an aggregate of the amount of the soft dollar payments for the bulk trade order and the amount of soft dollar payments that have previously been paid will exceed the amount of soft dollar payments to be paid within the predetermined period;
determine based on the prediction of an overpayment to restrict the amount of soft dollar payments for the bulk trade order and determine an amount of soft dollar payments that does not result in an overpayment of soft dollars;
determine based on the determined amount of soft dollar payments that does not result in the overpayment for the bulk trade order an amount of soft dollars to pay in accordance with the determined amount of soft dollar payments that does not result in the overpayment;
transmit to a device of a broker a first trade settlement payout for the portion of the block trade order and instructions to distribute soft dollar payments for the first trade settlement payout;
for the remaining portion of the block trade order, remove soft dollar payments from a second trade settlement payout for the remaining portion; and
transmit to the device of a broker the second trade settlement payout with the soft dollar payments removed.

23. The system of claim 17, wherein the computer program product further comprises instructions for causing the one or more processing devices to:
track an amount of soft dollar payments made to the service provider;
detect that the amount of soft dollar payments exceeds the amount of soft dollar payments specified in the soft dollar agreement; and
recapture an excess amount of soft dollar payments by transmitting to a device of a broker instructions to credit back to a trading institution the excess amount of soft dollar payments.

24. The system of claim 17, wherein the request to execute the trade order is transmitted to a device of a broker.

25. The computer-implemented method of claim 6, further comprising:
tracking an amount of soft dollar payments made to the service provider;
detecting that the amount of soft dollar payments exceeds the amount of soft dollar payments specified in the soft dollar agreement; and
recapturing an excess amount of soft dollar payments by transmitting to a device of a broker instructions to credit back to a trading institution the excess amount of soft dollar payments.

26. The computer program product of claim 14, further comprising instructions for causing the one or more processing devices to:
track an amount of soft dollar payments made to the service provider;
detect that the amount of soft dollar payments exceeds the amount of soft dollar payments specified in the soft dollar agreement; and
recapture an excess amount of soft dollar payments by transmitting to a device of a broker instructions to credit back to a trading institution the excess amount of soft dollar payments.

27. The system of claim 22, wherein the computer program product further comprises instructions for causing the one or more processing devices to:
track an amount of soft dollar payments made to the service provider;
detect that the amount of soft dollar payments exceeds the amount of soft dollar payments specified in the soft dollar agreement; and
recapture an excess amount of soft dollar payments by transmitting to a device of a broker instructions to credit back to a trading institution the excess amount of soft dollar payments.
